(19) United States
(12) Patent Application Publication
(10) Pub. No.: US 2003/0201369 A1
(43) Pub. Date: Oct. 30, 2003

(54) Suction cup with rivet cap assembly

(75) Inventor: Philip C. Dretzka, Cleveland Heights, OH (US)

Correspondence Address: D. Peter Hochberg Co., L.P.A., The Baker Building, 6th Floor, 1940 East 6th Street, Cleveland, OH, 44114-2294, US

(73) Assignee: InterDesign, Inc.

(21) Appl. No.: 10/132,650

(22) Filed: Apr. 24, 2002

(51) Int. Cl. A45D 42/14; F16B 47/00

(52) U.S. Cl. 248/206.2; 248/206.3; 248/683; 248/301

(57) ABSTRACT

A rivet assembly having improved mechanical and aesthetic qualities to secure suction cups to a functional member, such as a hook. The rivet assembly comprises a head portion and a base portion. The base portion is integrally formed with the suction cup and comprises an annular, outwardly projecting post which couples with a corresponding hollow and annular receiving portion located on the underside of the rivet head. The engagement between the two secures the suction cup to the functional member, such as a hook.

### BACKGROUND OF THE INVENTION

1. Field of the Invention

The present invention relates generally to a suction cup for securing a fixture to a smooth surface. More particularly, the present invention relates to an assembly for securing a suction cup made from a resilient material such as plastic or rubber to a fixture enabling the fixture to be secured to a smooth surface.

2. Description of the Prior Art

Suction cups attached to fixtures which in turn enable the fixtures to be secured to various smooth surfaces are well known in the industry and commonly used. Such suction cups may be attached to fixtures such as hooks, wire baskets, plastic baskets, garbage bag holders, wire or plastic shelves, soap dishes, soap holders, scouring pad holders, bottle holders, eyeglass holders, glare shields, support lights, plastic cups, and bathroom accessories such as toothbrush holders, wire frame shower hangers, shower seats, shower caddies, and the like.

Conventional suction cup-fixture assemblies generally employ a system wherein the posterior end of the suction cup comprises a head or knob and fits into a slot on the fixture. The slot generally has a diameter which can accommodate the size of the head upon compression of the head. Upon decompression the head of the suction cup returns to its natural form and size and is retained in place, thus enabling the suction cup to be secured to the fixture.

A major shortcoming is that the fixture is loosely held to the suction cup and occasionally tilts when objects are placed in the fixture off-center. This can easily cause the object to fall from the fixture and/or the fixture itself to become disengaged from the suction cup.

Another problem with such a conventional system is that suction cups attached to fixtures are commonly used in association with bathroom accessories and the like. The nature of such use causes the suction cups to become wet. Once wet, the suction cup becomes lubricated and the potential to become displaced from the fixture is increased.

Another problem with such conventional assemblies is that the suction cup becomes worn from constant use. This in turn also increases the potential that the suction cup head will become displaced or dislodged from the fixture to which it is secured.

Yet another problem with conventional assemblies is that they tend to be vulnerable to relatively heavy objects. Although the head of the suction cup has a wider diameter than the slot on the fixture in which the suction cup is secured, the downward force created by a relatively heavy fixture could force the head to be decompressed and to slip back through the slot causing the fixture to fall to the ground.

Therefore, there is an unsatisfied need to have a more efficient and more durable means of attaching suction cups to a fixture for securing the fixture to a smooth surface.

### SUMMARY OF THE INVENTION

It is an object of the present invention to provide a means for firmly securing a suction cup to a fixture.

It is another object of the present invention to provide a means for securing a suction cup to a fixture in a more durable and sturdy manner.

It is yet another object of the present invention to provide an assembly such that the resulting assembly is strong, thereby enabling the assembly to hold heavy objects when secured to a surface.

These and other objects of the invention may occur to those skilled in the art from the description to follow and from the appended claims.

### BRIEF DESCRIPTION OF THE DRAWINGS

FIG. 1 is a side view of the suction cup assembly secured to a hook.

FIG. 2 is a perspective view of a rivet cap assembly.

FIG. 3 is a perspective view of a rivet base protruding from a suction cup.

FIG. 4 is a side view of a suction cup with a rivet cap assembly.

FIG. 5 is a front view of a suction cup with a rivet cap assembly.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It will be evident, however, to one skilled in the art that the present invention may be practiced without these specific details.

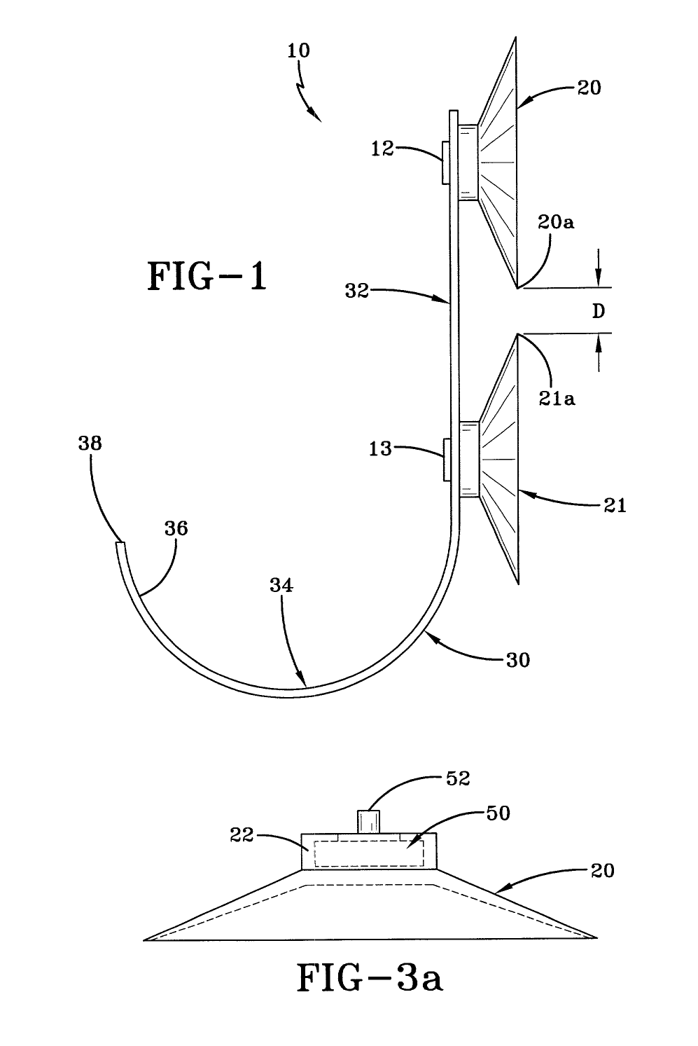

Referring now to FIG. 1, a preferred embodiment according to the present invention is shown being an assembly 10 and including a suction cup 20 with a rivet assembly 12 and a functional member 30. For purposes of this description only, assembly 10 is shown having rivet 12 secure suction cup 20 to functional member 30 where functional member 30 is a hook. It should be understood however that this particular illustration is for exemplary purposes only and it should be understood that suction cup 20 can be secured to any other type of functional member or fixture known in the art by rivet 12, such as wire baskets, plastic baskets, garbage bag holders, wire or plastic shelves, soap dishes, soap holders, scouring pad holders, bottle holders, eyeglass holders, glare shields, support lights, plastic cups, and bathroom accessories such as toothbrush holders, wire frame shower hangers, shower seats, shower caddies, and the like. It is also noted that for exemplary purposes only, suction cup 20 is shown in conjunction with a second suction cup 21, each being secured by rivet 12 and an additional rivet 13 respectively. However, any desirable number of suction cups 20 may be employed. When multiple suction cups 20 and 21 are employed, the minimum distance between edges of suction cups 20 and 21 can in this type of unit be 0.1 inch, such distance shown at reference “D”, and edges of suction cups 20 and 21 being defined by first edge 20a and second edge 21a.

Hook 30 can be any standard hook conventional in the art and comprising a straight body portion 32 and a curved portion 34. Body portion 32 extends downwardly into curved portion 34, which in turn extends outwardly and upwardly and ends at a substantially upward curve 36, including a tip 38, from which hook 30 can support other objects. Rivet 12 also is any type of standard rivet conventional in the art, such as oval head rivets, flat head rivets, countersunk rivets or any special purpose rivet specially designed for this particular application. It is appreciated that rivet 12 can be made of any standard material, such as aluminum, brass, copper, stainless steel or any alloy thereof and can additionally have any standard type of finish, such as black oxide, brass, nickel, passivation, tin, zinc clear, zinc yellow or zinc black.

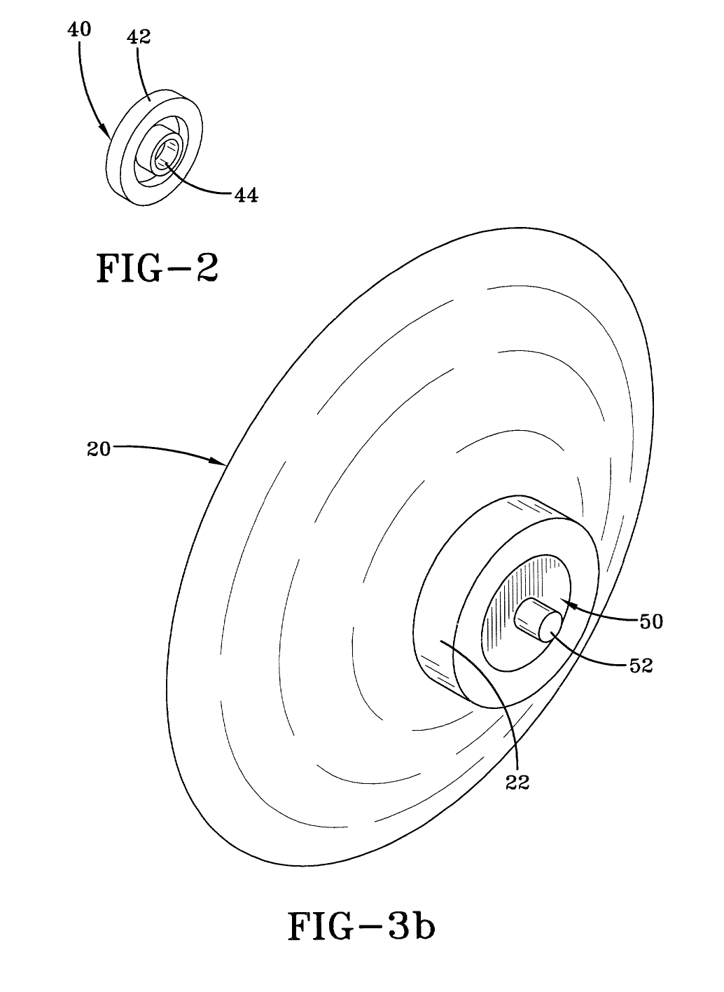

Turning now to FIG. 2, a rivet head, the female portion of rivet assembly 12, is shown and referred to generally at numeral 40. Head 40 comprises a top 42 and a receiving portion 44. Receiving portion 44 is a hollow, annular orifice which can slightly protrude outwardly from the underside of top 42. Receiving portion 44 is hollow so as to be able to receive a corresponding male portion, which is discussed in greater detail below.

Turning now to FIGS. 3a and 3b, a rivet base, the male portion of rivet 12, is shown and referred to generally at numeral 50. Rivet base 50 is formed in an integral manner with suction cup 20, via any conventional method known in the art, such as injection molding and the like. An annular neck portion 22 of suction cup 20 is centrally located on the non-suctioning side of suction cup 20 and is integrally formed around rivet base 50 thereby embedding rivet base 50 integrally and securely therein. Post 52 extends outwardly from rivet base 50 so as to couple with receiving portion 44 of rivet head 40 by means of an appropriate rivet gun or other riveting machine or device known in the art. Post 52 is substantially annular and has a diameter that is substantially the same as the diameter as that of receiving portion 44 of female head portion 40, thereby allowing a secure engagement between head 40 and base 50. Rivet base 50 is aligned accordingly with a slot 33 (FIG. 4) of hook body portion 32 and post 52 extends therethrough for coupling with receiving portion 44.

It should be appreciated of course that in an alternative embodiment, head portion 40 is the male portion and base portion 50 is the female portion. It should be further appreciated that rivet 20 as explained herein is just one example of a type of rivet that may be employed and that any alternative type of rivet may be used in lieu of the present rivet 12 to the same effect.

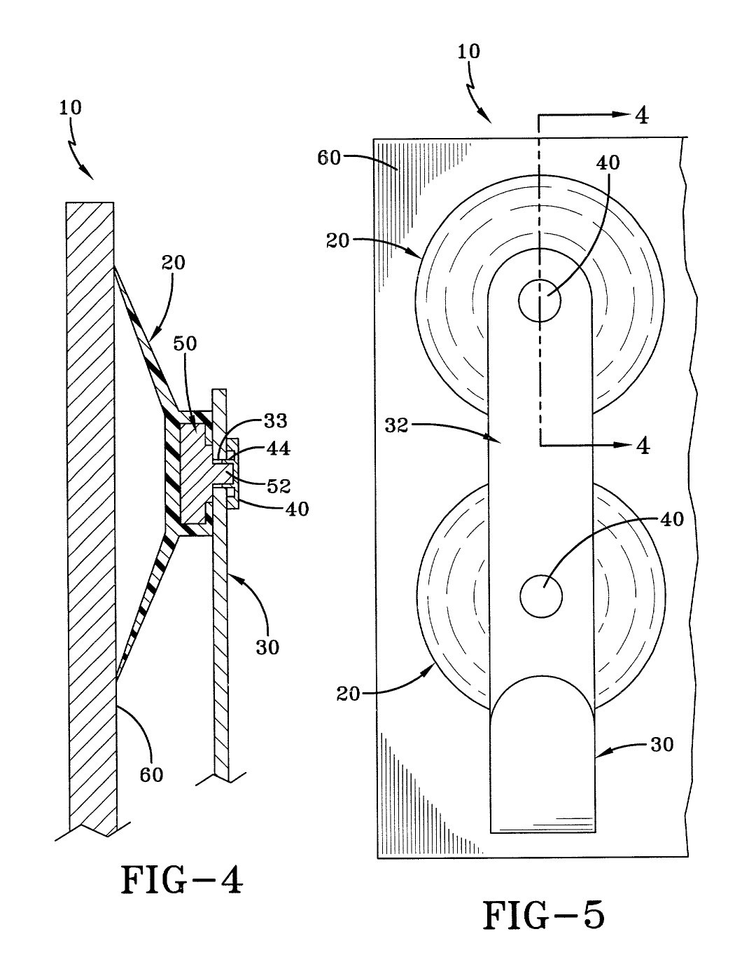

Turning now to FIGS. 4 and 5, assembly 10 of the present invention in shown in operation. Rivet base 50 is shown being integrally formed with suction cup 20 and having post 52 extending through slot 33 of hook body portion 32 to couple with receiving portion 44 of rivet head 40, thereby securing suction cup 20 to hook 30. Assembly 10 in turn can be secured to a vertical surface 60 via suction cup 20.

The present invention can be formed via any method conventional in the art, preferably via injection molding methods. For example, the plastic material employed for the formation of suction cup 20 can be melted down and inserted into a mold having a desirable suction cup shape and allowing for neck portion 22 to be formed thereon. Rivet base 50 is inserted into the liquefied plastic which is to form neck portion 22. The plastic inside the mold is allowed to cool into the desired shape of the mold, thereby incorporating rivet base 50 therein.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

What is claimed is:

1. A device from which objects my be supported, comprising:
a securing member having a neck portion thereon; and
a rivet having a first member and a second member, said first member being integrally formed with said neck portion of said securing member and said second member able to be connected with said first member thereby securing a functional member between said first member and said second member.

2. The device of claim 1 wherein said securing member is selected from the group consisting of a suction cup, a support to which is attached a magnet and a solid base with adhesive held thereon.

3. The device of claim 1 wherein said functional member is selected from the group consisting of a hook, a clip, a basket, a soap dish, a shower rack, a towel rack and a toothbrush dispenser.

4. The device of claim 1 wherein said first member of said rivet is a rivet base and said second member of said rivet is a rivet cap, said rivet base having a securing post thereon and said rivet cap having a receiving portion thereon and corresponding to and coupling with said receiving portion of said rivet cap.

5. The device of claim 1 wherein said first member and said second member are connected through an opening in said functional member.

6. A suction cup having an integrally molded fastener, comprising:
a neck on said suction cup having a portion of said fastener embedded therein, said fastener having a first member being connected to a second member and said members being connected through an opening in a functional member placed therebetween, said functional member being able to support other objects.

7. The suction cup of claim 6 wherein said fastener is a rivet and wherein said first member is a rivet base and said second member is a rivet cap, said rivet base having a securing post thereon and said rivet cap having a receiving portion thereon, corresponding to and coupling with said receiving portion of said rivet cap.

8. The suction cup of claim 6 wherein said functional member is selected from the group consisting of a hook, a clip, a basket, a soap dish, a shower rack, a towel rack and a toothbrush dispenser.

9. The suction cup of claim 6 wherein said suction cup is formed by thermoplastic injection molding.

10. A rivet assembly for securing a suction cup to a functional member, comprising:
a suction cup having a neck portion thereon;
a rivet cap having a receiving portion thereon; and
a rivet base having a securing post thereon for coupling said base with said receiving portion of said rivet cap, said base being embedded in said neck portion of said suction cup.

11. The rivet assembly of claim 10 wherein said functional member is selected from the group consisting of a hook, a clip, a basket, a soap dish, a shower rack, a towel rack and a toothbrush dispenser.

12. The rivet assembly of claim 10 wherein said base is embedded within said neck portion by thermoplastic injection molding methods.

13. The rivet assembly of claim 10 wherein functional member includes a body portion having an opening, and said securing post couples with said receiving portion through said opening to secure said suction cup to said functional member.
